(19) United States
(12) Patent Application Publication
(10) Pub. No.: US 2026/0072783 A1
(43) Pub. Date: Mar. 12, 2026

(54) MEMORY SYSTEM, MEMORY DEVICE, AND OPERATING METHOD OF THE MEMORY DEVICE

(71) Applicant: Samsung Electronics Co., Ltd., Suwon-si (KR)

(72) Inventors: Hoyoun Kim, Suwon-si (KR); Yeonjin Lee, Suwon-si (KR); Haewook Jeong, Suwon-si (KR)

(21) Appl. No.: 19/235,709

(22) Filed: Jun. 12, 2025

(30) Foreign Application Priority Data
Sep. 12, 2024 (KR) 10-2024-0125053
May 16, 2025 (KR) 10-2025-0063943

(51) Int. Cl. G06F 11/10

(52) U.S. Cl. CPC G06F 11/1016; G06F 11/1048; G06F 11/1068

(57) ABSTRACT

An operating method of a memory device includes reading, from a memory cell array in the memory device, read data including at least one piece of erased bit data, generating erasure position information based on the read data, generating a partial syndrome associated with non-erased bit data of the read data, based on the erasure position information, an H-matrix, and the read data, generating, based on the erasure position information and the H-matrix, an erasure syndrome set associated with the at least one piece of erased bit data and including a plurality of erasure syndromes, determining whether an erasure syndrome identical to the partial syndrome is present in the erasure syndrome set, and generating corrected data by correcting the read data based on the erasure syndrome identical to the partial syndrome.

### CROSS-REFERENCE TO RELATED APPLICATIONS

This application is based on and claims priority under 35 U.S.C. § 119 to Korean Patent Application Nos. 10-2024-0125053, filed on Sep. 12, 2024, and 10-2025-0063943, filed on May 16, 2025, in the Korean Intellectual Property Office, the disclosure of which is incorporated by reference herein in its entirety.

### BACKGROUND

The inventive concept relates to a semiconductor memory, and more particularly, to a memory system, a memory device, and an operating method of the memory device.

Semiconductor memories are classified into volatile memory devices that lose data stored therein when the power supply is cut off, such as static random-access memory (RAM) (SRAM) and dynamic RAM (DRAM), and non-volatile memory devices that retain data stored therein even when the power supply is cut off, such as a flash memory device, phase-change RAM (PRAM), magnetic RAM (MRAM), resistive RAM (RRAM), and ferroelectric RAM (FRAM).

Recently, as electronic products operate at higher speed and consume less power, fast read/write operations and low operating voltages are required for semiconductor devices embedded in the electronic products. In response to such requirements, research has been conducted into ferroelectric memories that have ferroelectricity and maintain a spontaneous polarization by aligning the internal electric dipole moments even when no electric field is applied from the outside. In particular, highly integrated ferroelectric memory is capable of high-speed reading and writing operations and is non-volatile, and thus it is emerging as next-generation memory. However, a ferroelectric memory may occur an erasure due to issues such as charge sensing retention, leakage, and fatigue. Therefore, a new approach may be needed to resolve such an erasure.

### SUMMARY

The inventive concept provides a memory system, a memory device, and an operating method of the memory device with improved reliability.

According to an aspect of the inventive concept, there is provided an operating method of a memory device. The operating method includes reading, from a memory cell array in the memory device, read data including at least one piece of erased bit data, generating erasure position information based on the read data, generating a partial syndrome associated with non-erased bit data of the read data, based on the erasure position information, an H-matrix, and the read data, generating, based on the erasure position information and the H-matrix, an erasure syndrome set associated with the at least one piece of erased bit data and including a plurality of erasure syndromes, determining whether an erasure syndrome identical to the partial syndrome is present in the erasure syndrome set, and generating corrected data by correcting the read data based on the erasure syndrome identical to the partial syndrome.

According to another aspect of the inventive concept, there is provided a memory device. The memory device includes a memory cell array including a plurality of memory cells, and a correction circuit including an error correction circuit and an erasure correction circuit, the error correction circuit being configured to perform an error detection and correction operation on read data read from the memory cell array, and the erasure correction circuit being configured to perform an erasure correction operation on the read data. The erasure error correction circuit includes an erasure position detector configured to generate erasure position information based on the read data including at least one piece of erased bit data, a syndrome generator configured to generate a partial syndrome associated with non-erased bit data of the read data, based on the erasure position information, an H-matrix, and the read data, an erasure syndrome set generator configured to generate, based on the erasure position information and the H-matrix, an erasure syndrome set associated with erased bit data of the read data and including a plurality of erasure syndromes, a comparator configured to determine whether an erasure syndrome identical to the partial syndrome is present in the erasure syndrome set, and a data corrector configured to generate corrected data by correcting the read data based on the erasure syndrome identical to the partial syndrome.

According to another aspect of the inventive concept, there is provided a memory system. The memory system includes a memory device including a memory cell array and a correction circuit, and a memory controller configured to store data in the memory device or read data stored in the memory device. The correction circuit includes an erasure position detector configured to generate erasure position information based on the read data including at least one piece of erased bit data, a syndrome generator configured to generate a partial syndrome associated with non-erased bit data of the read data, based on the erasure position information, an H-matrix, and the read data, an erasure syndrome set generator configured to generate, based on the erasure position information and the H-matrix, an erasure syndrome set associated with erased bit data of the read data and including a plurality of erasure syndromes, a comparator configured to determine whether an erasure syndrome identical to the partial syndrome is present in the erasure syndrome set, and a data corrector configured to generate corrected data by correcting the read data based on the erasure syndrome identical to the partial syndrome.

### BRIEF DESCRIPTION OF THE DRAWINGS

Embodiments will be more clearly understood from the following detailed description taken in conjunction with the accompanying drawings in which:

FIG. 1 is a block diagram illustrating a memory system according to an embodiment;

FIG. 2 is a block diagram illustrating an example of a memory device of FIG. 1 according to an embodiment;

FIG. 3A is a circuit diagram illustrating an example of a memory cell of FIG. 2;

FIG. 3B is a graph illustrating a ferroelectric cell capacitor of a memory cell of FIG. 3A;

FIG. 3C is a graph illustrating a ferroelectric cell capacitor;

FIG. 4 is a flowchart illustrating an example of an operating method of the memory device of FIG. 1 according to an embodiment;

FIG. 5A is a block diagram illustrating a correction circuit of FIG. 1 according to an embodiment;

FIG. 5B is a block diagram illustrating an erasure correction circuit according to an embodiment;

FIG. 5C is a block diagram illustrating an error correction circuit according to an embodiment;

FIGS. 6A to 6C are diagrams illustrating an operation of the correction circuit of FIG. 1 according to an embodiment;

FIG. 7 is a diagram illustrating an operation of the correction circuit of FIG. 1 according to an embodiment;

FIGS. 8A and 8B are diagrams illustrating an operation of the correction circuit of FIG. 1 according to an embodiment;

FIGS. 9A and 9B are diagrams illustrating an operation of the correction circuit of FIG. 1 according to an embodiment;

FIGS. 10A and 10B are diagrams illustrating an operation of the correction circuit of FIG. 1 according to an embodiment;

FIG. 11 is a diagram illustrating an operation of the correction circuit of FIG. 1 according to an embodiment;

FIG. 12 is a flowchart illustrating an example of an operating method of the memory device of FIG. 1 according to an embodiment;

FIGS. 13A and 13B are block diagrams illustrating a memory system according to an embodiment; and

FIG. 14 is a diagram illustrating a system according to an embodiment.

### DETAILED DESCRIPTION OF THE EMBODIMENTS

Hereinafter, embodiments are described in detail and clearly to such an extent that one of ordinary skill in the art may easily implement the inventive concept.

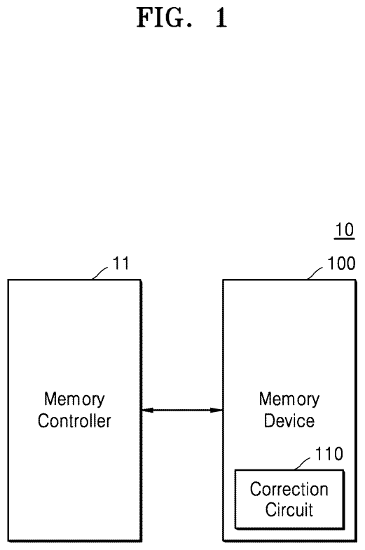

FIG. 1 is a block diagram illustrating a memory system according to an embodiment.

Referring to FIG. 1, a memory system 10 may include a memory controller 11 and a memory device 100. In an embodiment, the memory system 10 may be one of information processing devices configured to process various information and store the processed information, such as a personal computer (PC), a laptop, a server, a workstation, a smartphone, a tablet PC, a digital camera, and a black box.

The memory controller 11 may store data in the memory device 100 or read data stored in the memory device 100. For example, the memory controller 11 may transmit a clock signal and a command/address signal to the memory device 100 and may exchange a data signal and a data strobe signal with the memory device 100. In an embodiment, data may be transmitted from the memory controller 11 to the memory device 100 or from the memory device 100 to the memory controller 11 through the data signal and the data strobe signal. In an embodiment, the memory controller 11 and the memory device 100 may communicate with each other via a double data rate (DDR) interface or a low-power DDR (LPDDR) interface, but the scope of the inventive concept is not limited thereto.

The memory device 100 may operate under control by the memory controller 11. In an embodiment, the memory device 100 may be a dynamic random-access memory (RAM) (DRAM) device. In an embodiment, the memory device 100 may be a ferroelectric RAM (FeRAM) device. The memory device 100 may be FeRAM that senses, as data, a cell voltage stored in a memory cell. Here, the term “FeRAM” may also be referred to as “FRAM.” The scope of the inventive concept is not limited thereto, and the memory device 100 may include a volatile memory, such as static RAM (SRAM), or a non-volatile memory, such as flash memory, phase-change RAM (PRAM), and/or resistive RAM (RRAM).

In an embodiment, the memory device 100 may include a correction circuit 110. The correction circuit 110 may be configured to detect and correct an error in data stored in the memory device 100. The correction circuit 110 may perform an error detection and correction operation. The correction circuit 110 may perform an erasure correction operation.

In an embodiment, the correction circuit 110 may perform an error detection and correction operation. For example, the correction circuit 110 may generate parity data by performing error correction code (ECC) encoding on first data received from the memory controller 11. The memory device 100 may store the first data received from the memory controller 11 and the parity data generated by the correction circuit 110 together. While the memory device 100 is operating, an error may occur in the first data stored in the memory device 100 due to various factors. When a read request for the first data is generated by the memory controller 11, the correction circuit 110 may perform ECC decoding based on the first data and the corresponding parity data to correct the error occurred in the first data. The memory device 100 may transmit the corrected first data to the memory controller 11.

The correction circuit 110 may perform an erasure correction operation. For example, the term “erasure” is used to indicate a bit that is difficult to determine as either a first value (e.g., ‘1’) or a second value (e.g., ‘0’). For example, erasure as used herein refers to a logic state indicating a value other than the first value (e.g., ‘1’) and the second value (e.g., ‘0’) during data processing. For example, erasure may indicate a third value (e.g., ‘X’). For example, erasure may refer to an error in read data, wherein a position of the error is known, but a value thereof is unknown.

The memory device 100 may read, from a memory cell array, read data that does not include erased bit data. The correction circuit 110 may also perform a general error detection and correction operation on the read data that does not include erased bit data. The correction circuit 110 may perform both an erasure correction operation and an error detection and correction operation.

Non-erased bit data may have either the first value (e.g., ‘1’) or the second value (e.g., ‘0’). Erased bit data may have the third value (e.g., ‘X’). The erased bit data may indicate the third value (e.g., ‘X’) representing a state in which data is not determined as either the first value (e.g., ‘1’) or the second value (e.g., ‘0’).

An error detection and correction operation may refer to an operation of correcting read data including only non-erased bit data. The error detection and correction operation may refer to an operation of correcting read data that does not include erased bit data. That is, the error detection and correction operation may refer to a correction operation on read data including data indicating the first value (e.g., ‘1’) or the second value (e.g., ‘0’). An erasure correction operation may refer to an operation of correcting read data including erased bit data. The erasure correction operation may refer to an operation of correcting read data including erased bit data and non-erased bit data. That is, the erasure correction operation may refer to a correction operation on read data including data indicating the first value (e.g., ‘1’), the second value (e.g., ‘0’), or the third value (e.g., ‘X’).

The memory device 100 may perform an erasure correction operation. For example, when the memory device 100 performs an erasure correction operation, it is assumed that read data only includes erased bit data and does not include any other errors (or additional errors). The read data may include user data and parity data. Alternatively, the read data may include user data, metadata, and parity data. The memory device 100 may perform an erasure correction operation that is separate from an error correction operation. The memory device 100 may receive read data including at least one piece of erased bit data. The memory device 100 may generate erasure position information based on the read data. The memory device 100 may generate a partial syndrome and an erasure syndrome set. The memory device 100 may determine an erasure syndrome identical to the partial syndrome in the erasure syndrome set. The memory device 100 may correct the read data based on the determined erasure syndrome.

An error detection and correction operation may be different from an erasure correction operation. When erased bit data is detected in read data, the correction circuit 110 may recognize a position of the erased bit data. Because the erased bit data has the third value (e.g., ‘X’), the correction circuit 110 may detect the position of the erased bit data even without performing a separate calculation operation. For example, even without performing a calculation operation such as an error correction operation, a position of an erased bit may be detected by determining whether each individual bit has the third value, based on an output voltage value of each individual bit. Alternatively, the position of the erased bit may be detected through a mathematical calculation formula, based on the determined erased bit data. However, when an error such as a bit flip occurs, the correction circuit 110 may find a position of the error through a separate calculation.

The memory device 100 may perform an erasure correction operation to provide improved correction capability to an error correction operation. For example, the memory device 100 may arbitrarily determine bit data corresponding to a memory cell in an erased state as either the first value (e.g., ‘1’) or the second value (e.g., ‘0’). The memory device 100 may correct up to 1 bit by performing an error correction operation on read data including only non-erased bit data. Alternatively, the memory device 100 may determine the bit data corresponding to the memory cell in the erased state as the third value (e.g., ‘X’). The memory device 100 may correct up to 2 bits by performing an erase correction operation on read data including erased bit data and non-erased bit data. Accordingly, the memory device 100 may be provided with improved reliability.

As described above, the correction circuit 110 may perform an error detection and correction operation. Also, the correction circuit 110 may perform an erasure correction operation. Accordingly, the correction circuit 110 may also perform an erasure decoding operation by using a syndrome decoding method utilized for an error detection and correction operation. The memory device 100 may perform an erasure correction operation without major structural changes to an existing correction circuit.

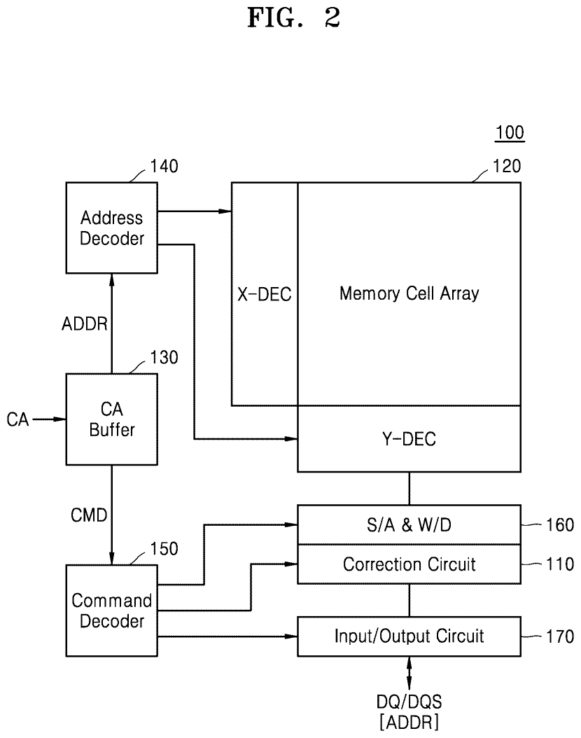

FIG. 2 is a block diagram illustrating an example of the memory device of FIG. 1 according to an embodiment.

Referring to FIGS. 1 and 2, the memory device 100 may include the correction circuit 110, a memory cell array 120, a command/address (CA) buffer 130, an address decoder 140, a command decoder 150, a sense amplifier and write driver 160, and an input/output circuit 170.

The correction circuit 110 may generate parity data by performing ECC encoding on data to be stored in the memory cell array 120. Alternatively, the correction circuit 110 may perform ECC decoding based on data and parity data received from the memory cell array 120 to correct an error in the data. The correction circuit 110 may receive, from the memory cell array 120, read data including at least one piece of erased bit data. A configuration and operation of the correction circuit 110 are described in more detail below with reference to the drawings.

For example, the correction circuit 110 may include an ECC encoder (not shown) and an ECC decoder (not shown). The ECC encoder may generate parity data by performing ECC encoding on write data to be stored in the memory cell array 120. The write data and parity data may be stored in the memory cell array 120 through the sense amplifier and write driver 160. In this regard, a sense amplifier may sense a voltage of each bit line and output a bit value of each bit line. Also, the sense amplifier may sense the voltage of each bit line, determine whether the bit line has the third value, and output an erased bit value. A sense amplifier connected to a plurality of bit lines may output read data or erased bit data according to an operating time or operating mode. When the sense amplifier determines an erased bit value of each bit line, an erased bit may be determined by comparing a voltage of the bit line with a predetermined reference voltage. In an embodiment, read data RD may include data read from the memory cell array 120 and erased bit data. That is, when an operation of reading data stored in the memory cell array 120 is performed, the sense amplifier may output the erased bit data as an output that is different from an output of the data read from the memory cell array 120. Alternatively, the erased bit data and the read data may be output sequentially. As a result, the read data RD may include the erased bit data.

The ECC decoder may output error-corrected read data by performing ECC decoding based on read data and parity data read from the memory cell array 120. The read data may include user data and parity data. The read data may be a codeword.

In an embodiment, the correction circuit 110 may receive an erasure correction enable signal. The correction circuit 110 may perform a general error detection and correction operation before receiving the erasure correction enable signal. The correction circuit 110 may perform an erasure correction operation, in response to the erasure correction enable signal. The correction circuit 110 may perform an erasure correction operation on read data including at least one piece of erased bit data.

In an embodiment, the correction circuit 110 may perform an error detection and correction operation in a first mode and may perform an erasure correction operation in a second mode. The correction circuit 110 may operate in the first mode in response to a disabled erasure correction enable signal. The correction circuit 110 may operate in the second mode in response to an enabled erasure correction enable signal.

The correction circuit 110 may perform an error correction operation based on a disabled erasure correction enable signal. The correction circuit 110 may receive read data including non-erased bit data. The correction circuit 110 may perform an error detection and correction operation on read data including only non-erased bit data.

The correction circuit 110 may perform an erasure correction operation based on an enabled erasure correction enable signal. The correction circuit 110 may receive read data including erased bit data and non-erased bit data. The correction circuit 110 may perform an erasure correction operation on read data including erased bit data and non-erased bit data.

The memory cell array 120 may include a plurality of memory cells. The plurality of memory cells may be connected to a plurality of word lines and a plurality of bit lines, respectively. Alternatively, the plurality of memory cells may be connected to a plurality of word lines, a plurality of bit lines, and a plurality of plate lines, respectively. In an embodiment, the plurality of word lines may be driven by an X-decoder (or row decoder) X-DEC, and the plurality of bit lines may be driven by a Y-decoder (or column decoder) Y-DEC.

The CA buffer 130 may be configured to receive command/address signals CA and temporarily store or buffer the received signals. The address decoder 140 may decode address signals ADDR stored in the CA buffer 130. The address decoder 140 may control the X-decoder X-DEC and the Y-decoder Y-DEC based on a decoding result of the address signals ADDR.

The command decoder 150 may decode a command CMD stored in the CA buffer 130. The command decoder 150 may control components of the memory device 100 based on a decoding result of the command CMD. For example, when a command signal stored in the CA buffer 130 is a write command (i.e., when a command received from the memory controller 11 is a write command), the command decoder 150 may control the correction circuit 110 so that data received through the input/output circuit 170 is written to the memory cell array 120 (i.e., perform ECC encoding), and may control an operation of the sense amplifier and write driver 160 (i.e., activate the write driver).

Alternatively, when a command signal stored in the CA buffer 130 is a read command (i.e., when a command received from the memory controller 11 is a read command), the command decoder 150 may control the correction circuit 110 so that data stored in the memory cell array 120 is read (i.e., perform ECC decoding), and may control an operation of the sense amplifier and write driver 160 (i.e., activate the sense amplifier).

The sense amplifier and write driver 160 may read data from the memory cell array 120 or write data to the memory cell array 120 through the plurality of bit lines under control by the command decoder 150. The sense amplifier and write driver 160 may detect erased bit data. When the erased bit data is detected, the sense amplifier and write driver 160 may transmit the erasure correction enable signal to the correction circuit 110. The sense amplifier and write driver 160 may transmit, to the correction circuit 110, read data including at least one piece of erased bit data.

The input/output circuit 170 may receive data DATA from the memory controller 11 or transmit data DATA to the memory controller 11, based on a data signal DQ and a data strobe signal DQS.

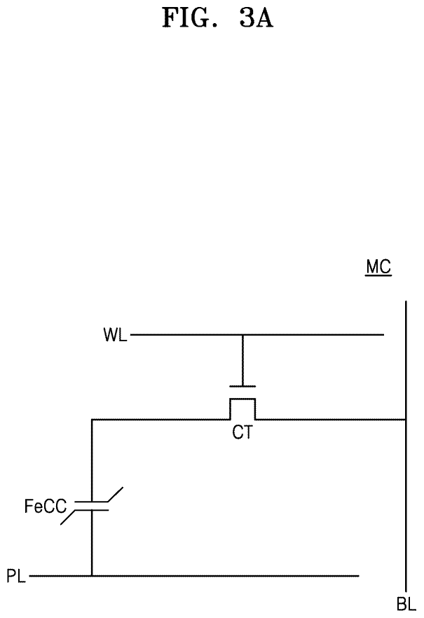

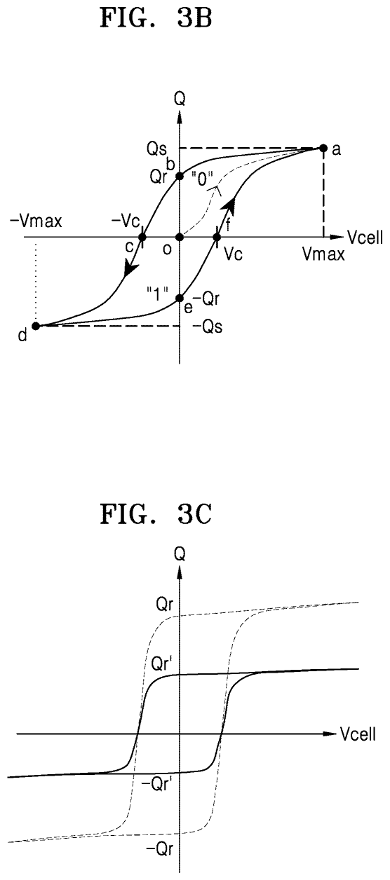

FIG. 3A is a circuit diagram illustrating an example of a memory cell of FIG. 2. FIG. 3B is a graph illustrating a ferroelectric cell capacitor of a memory cell of FIG. 3A. FIG. 3C is a graph illustrating a ferroelectric cell capacitor.

Referring to FIGS. 2 and 3A, the memory cell array 120 may include a plurality of memory cells MC. The plurality of memory cells MC may be connected to a plurality of word lines WLs, a plurality of bit lines BLs, and a plurality of plate lines PLs, respectively.

Each of the memory cells MC may include a cell transistor CT and a ferroelectric cell capacitor FeCC. A gate terminal of the cell transistor CT may be connected to one of the word lines WLs of the memory cell array 120. A first terminal of the cell transistor CT may be connected to one of the bit lines BLs of the memory cell array 120. A second terminal of the cell transistor CT may be connected to a first terminal of the ferroelectric cell capacitor FeCC. A second terminal of the ferroelectric cell capacitor FeCC may be connected to one of the plate lines PLs of the memory cell array 120. The ferroelectric cell capacitor FeCC may store charges of a capacity corresponding to data. The memory cell MC may store, in the ferroelectric cell capacitor FeCC, a cell voltage Vcell having a size that specifies data.

The ferroelectric cell capacitor FeCC may include a material having ferroelectricity. In this regard, the ferroelectric cell capacitor FeCC may include, as the material having ferroelectricity, one of lead zirconate titanate (PZT), strontium bismuth tantalate (SBT), and lanthanum-doped bismuth titanate (BLT). Also, the ferroelectric cell capacitor FeCC may include, for example, at least one of hafnium oxide, hafnium zirconium oxide, zirconium oxide, barium strontium titanium oxide, barium titanium oxide, and lead zirconium titanium oxide. Here, hafnium zirconium oxide may be a material in which hafnium oxide is doped with zirconium (Zr) or may be a compound of hafnium (Hf), zirconium (Zr), and oxygen (O). The ferroelectric cell capacitor FeCC may further include a doping element doped into the material described above. The doping element may be an element selected from aluminum (Al), titanium (Ti), niobium (Nb), lanthanum (La), yttrium (Y), magnesium (Mg), silicon (Si), calcium (Ca), cerium (Ce), dysprosium (Dy), erbium (Er), gadolinium (Gd), germanium (Ge), scandium (Sc), strontium (Sr), and tin (Sn).

Referring to FIG. 3B, it can be seen that a hysteresis loop characteristic of the ferroelectric cell capacitor FeCC is shown. In the graph of FIG. 3B, a horizontal axis indicates a cell voltage, and a vertical axis indicates a charge amount of the ferroelectric cell capacitor FeCC. Here, Qr indicates a remnant charge amount, Qs indicates a saturation charge amount, and Vc indicates a coercive voltage. The coercive voltage indicates a magnitude of a voltage that causes a total charge amount of the ferroelectric cell capacitor FeCC to be 0 C, and the remnant charge amount and the saturation charge amount are described below.

Referring to FIG. 3B, it can be seen that a point o, at which the cell voltage Vcell is 0 V and in an initial state, is shown. When a level of the cell voltage Vcell applied to the ferroelectric cell capacitor FeCC gradually increases from 0 V, as indicated by a dotted line in FIG. 3B, a polarization may occur in the ferroelectric cell capacitor FeCC, and the total charge amount of the ferroelectric cell capacitor FeCC may increase to Qs (a point a). In this regard, a state at the point a, in which the level of the cell voltage Vcell applied to the ferroelectric cell capacitor FeCC is greater than a level of a first voltage (e.g., the coercive voltage Vc), may be referred to as a saturation polarization of the ferroelectric cell capacitor FeCC. Here, a level of the first voltage may be Vmax.

In a saturation polarization state, when the level of the cell voltage Vcell applied to the ferroelectric cell capacitor FeCC decreases, a charge amount Q of the ferroelectric cell capacitor FeCC may decrease along an upper solid line (from the point a to a point b) rather than along the dotted line in reverse. At the point b shown in FIG. 3B, although the level of the cell voltage Vcell applied to the ferroelectric cell capacitor FeCC is 0 V, the total charge amount of the ferroelectric cell capacitor FeCC has a finite value of Qr, rather than 0 C, wherein Qr may be referred to as a remnant charge amount.

At the point b, when a voltage having a negative level (i.e., a reverse voltage) is applied to the ferroelectric cell capacitor FeCC and a magnitude of the reverse voltage gradually increases, a polarization in the opposite direction may occur past point c, at which the total charge amount C becomes 0 C, and thus, saturation may occur at a point d.

At the point d, when the magnitude of the reverse voltage applied to the ferroelectric cell capacitor FeCC decreases and a magnitude of a forward voltage applied thereto increases through a point e, the total charge amount C of the ferroelectric cell capacitor FeCC may move along a solid line (solid line defa) connecting points d, e, f, and a together.

For example, the total charge amount C of the ferroelectric cell capacitor FeCC, which corresponds to a level of a voltage applied to one ferroelectric cell capacitor FeCC, may correspond to two solid lines (solid line abcd and solid line defa). Such a change in value depending on the history of a process may be referred to as a hysteresis loop characteristic.

In the graph of FIG. 3C, a horizontal axis indicates the cell voltage, and a vertical axis indicates the charge amount of the ferroelectric cell capacitor FeCC. In the graph of FIG. 3C, a hysteresis loop characteristic of the ferroelectric cell capacitor FeCC in a first cycle is shown by a dotted line, and a hysteresis loop characteristic of the ferroelectric cell capacitor FeCC in a second cycle is shown by a solid line. Here, the term “cycle” may refer to a write/erase operation of the memory cell MC or an access operation of the memory cell MC. For example, the first cycle may be a write/erase operation while a first number of write/erase operations less than a threshold value are performed, and the second cycle may be a write/erase operation while a second number of write/erase operations equal to or greater than the threshold value are performed.

In FeRAM or FRAM, due to issues such as charge sensing retention, leakage, and fatigue, an erasure, which is a state in which data stored in a memory, that is, a codeword, may not be accurately determined as 0 or 1, may occur. Due to the nature of FeRAM, such an erasure may occur during repetitive write/erase cycles and may adversely affect the reliability and data integrity of the memory. A new approach may be needed to resolve such an erasure.

A remnant polarization may decrease depending on the number of access operations (read or write operations, hereinafter referred to as normal operations) or the number of operations applied to a ferroelectric memory cell, and thus, a ferroelectric material may enter a fatigued state. Alternatively, as the number of write/erase cycles of the memory cell MC increases, a remnant polarization may decrease.

A hysteresis loop (solid line) of a ferroelectric in a fatigued state has lower remnant polarizations (i.e., Qr′ and −Qr′) compared to remnant polarizations (i.e., Qr and −Qr) of a hysteresis loop (dotted line) of the ferroelectric in an initial state.

For example, as normal operations (or write and erase operations) are performed, that is, as fatigue accumulates in the ferroelectric memory cell, a difference between the two remnant polarizations (Qr′ and −Qr′) of the hysteresis loop of the ferroelectric may continuously decrease. As a result, the difference between the remnant polarizations (Qr′ and −Qr′) may decrease, and an error may occur in a sensing operation of sensing a logic level of data stored in the ferroelectric memory cell. Accordingly, the sense amplifier and write driver 160 may transmit, to the correction circuit 110, read data including at least one piece of erased bit data. The term “erased bit data” may refer to bit data having an erased state. For example, erased bit data may refer to bit data having the third value (e.g., ‘X’).

The memory device 100 may read read data RD from the memory cell array 120. It is assumed that the read data RD includes at least one piece of erased bit data and at least one piece of non-erased bit data. Non-erased bit data may have either the first value (e.g., ‘1’) or the second value (e.g., ‘0’). Erased bit data may have the third value (e.g., ‘X’). The first value, the second value, and the third value may be different from one another.

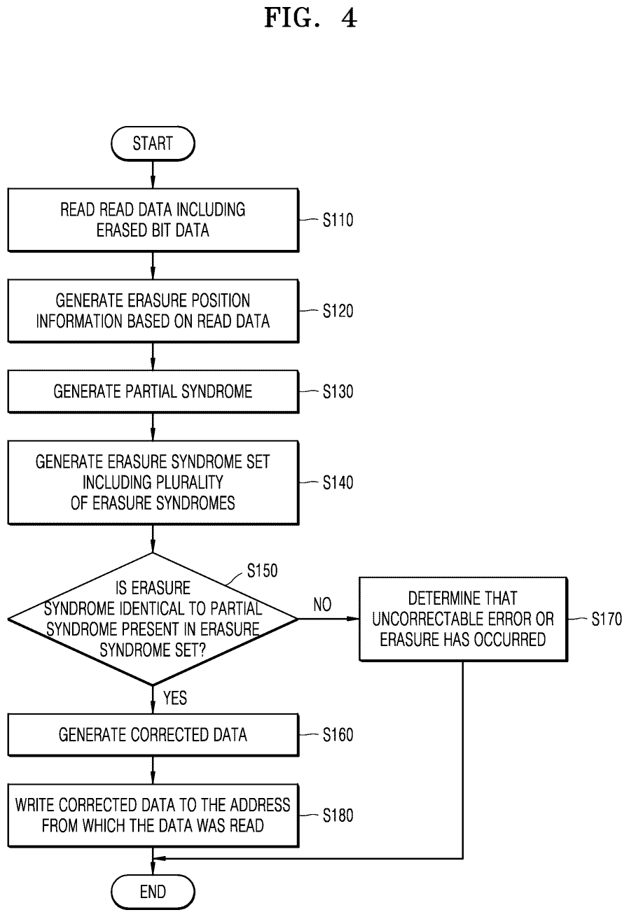

FIG. 4 is a flowchart illustrating an example of an operating method of the memory device of FIG. 1 according to an embodiment.

Referring to FIGS. 1 and 4, the memory device 100 may perform an erasure correction operation. In operation S110, the memory device 100 may read read data RD including erased bit data. For example, the read data RD may include user data and parity data.

In operation S120, the memory device 100 may generate erasure position information EP_INFO based on the read data RD. The memory device 100 may generate erasure position information EP_INFO indicating position information of the erased bit data included in the read data RD.

In operation S130, the memory device 100 may generate a partial syndrome PS. For example, the partial syndrome PS may be a syndrome associated with non-erased bit data. The partial syndrome PS may be a syndrome of column vectors corresponding to non-erased bit data in an H-matrix H-MAT. The memory device 100 may generate transformed data TD by setting the erased bit data in the read data RD to ‘0’. The memory device 100 may generate the partial syndrome PS based on the transformed data TD and the H-matrix H-MAT.

In operation S140, the memory device 100 may generate an erasure syndrome set ESS including a plurality of erasure syndromes. For example, an erasure syndrome may be a syndrome associated with the erased bit data. The memory device 100 may generate a partial H-matrix including column vectors corresponding to the erased bit data. For example, the partial H-matrix may be a portion of the H-matrix H-MAT and may include column vectors corresponding to the erased bit data, from among column vectors included in the H-matrix H-MAT. The memory device 100 may generate a binary combination matrix based on the number of pieces of erased bit data. For example, the binary combination matrix may be a matrix including column vectors of which elements are combinations that may be expressed as binary numbers. The number of elements included in a column vector may be equal to the number of pieces of erased bit data in the read data RD. The memory device 100 may generate the erasure syndrome set ESS based on the partial H-matrix and the binary combination matrix.

In operation S150, the memory device 100 may determine whether an erasure syndrome identical to the partial syndrome PS is present in the erasure syndrome set ESS. The memory device 100 may compare the erasure syndromes included in the erasure syndrome set ESS with the partial syndrome PS. The memory device 100 may find an erasure syndrome identical to the partial syndrome PS in the erasure syndrome set ESS. The memory device 100 may generate a comparison result. When an erasure syndrome identical to the partial syndrome PS is present in the erasure syndrome set ESS, the memory device 100 may perform operation S160, and when an erasure syndrome identical to the partial syndrome PS is not present in the erasure syndrome set ESS, the memory device 100 may perform operation S170.

In operation S160, the memory device 100 may generate corrected data CD. The memory device 100 may generate the corrected data CD by correcting the read data RD based on the erasure syndrome identical to the partial syndrome PS. The memory device 100 may correct the read data RD based on the comparison result. The memory device 100 may determine a value of the erased bit data in the read data RD based on the comparison result. The memory device 100 may generate the corrected data CD and output the corrected data CD.

In operation S170, the memory device 100 may determine that an uncorrectable error or erasure has occurred. The memory device 100 may regard the erasure correction operation as a failure. The memory device 100 may determine whether an uncorrectable error correction code (UECC) has occurred. The memory device 100 may determine that a UECC has occurred for the read data RD read from the memory cell array 120.

In operation S180, the memory device 100 may perform a write operation on a memory address from which the corrected data CD, in which an erased bit has been corrected, has been read. Such an erasure correction operation may be performed when the memory device 100 receives a read command or when the memory device 100 is in an idle state in which no command is received. By performing the erasure correction operation, the reliability of the memory device 100 may be further increased compared to when the memory device 100 only performs an error correction operation.

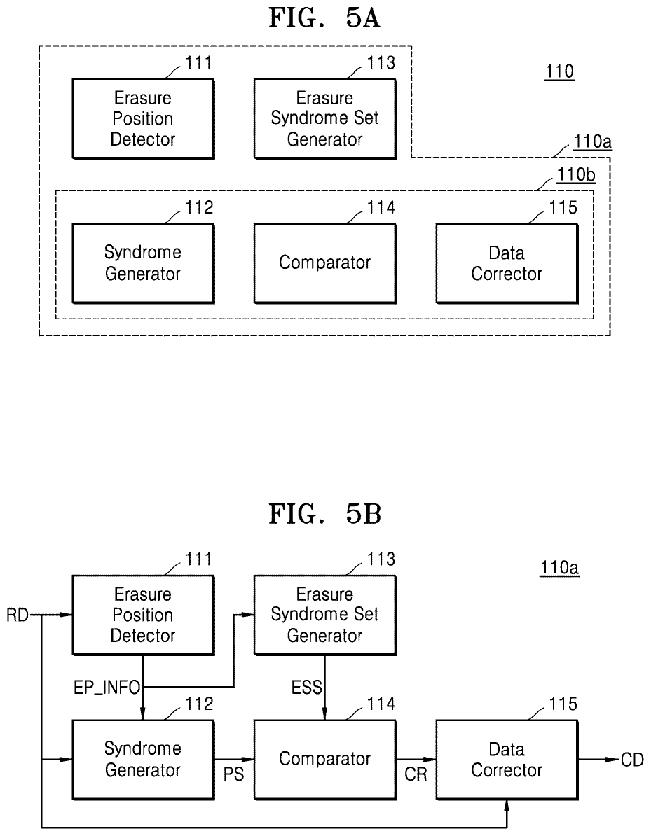

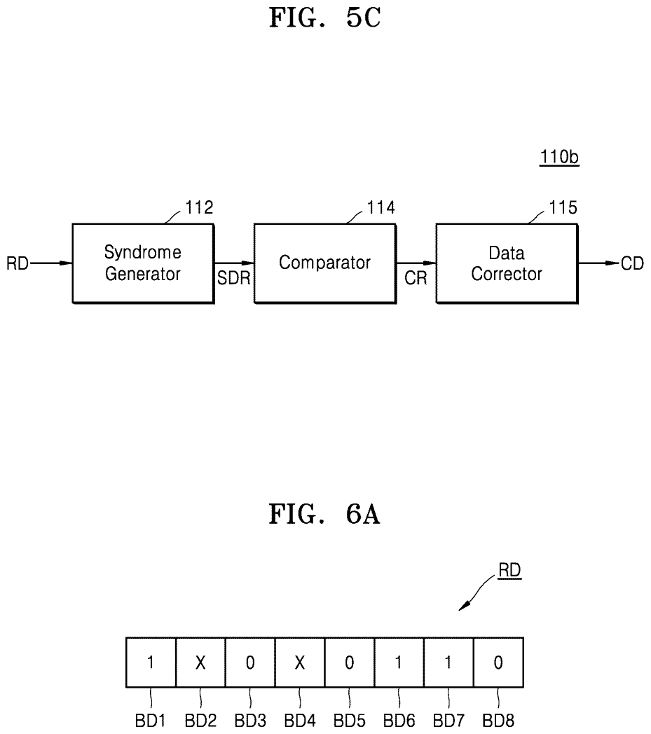

FIG. 5A is a block diagram illustrating the correction circuit of FIG. 1 according to an embodiment. FIG. 5B is a block diagram illustrating an erasure correction circuit according to an embodiment. FIG. 5C is a block diagram illustrating an error correction circuit according to an embodiment.

Referring to FIGS. 1 and 5A, the correction circuit 110 may include an erasure position detector 111, a syndrome generator 112, an erasure syndrome set generator 113, a comparator 114, and a data corrector 115. The correction circuit 110 may include an erasure correction circuit 110a and an error correction circuit 110b. For example, the error correction circuit 110b may be an ECC circuit.

The erasure correction circuit 110a may include the erasure position detector 111, the syndrome generator 112, the erasure syndrome set generator 113, the comparator 114, and the data corrector 115. The erasure correction circuit 110a may perform an erasure correction operation. The error correction circuit 110b may include the syndrome generator 112, the comparator 114, and the data corrector 115. The error correction circuit 110b may perform an error detection and correction operation. The syndrome generator 112, the comparator 114, and the data corrector 115 may be shared between the erasure correction circuit 110a and the error correction circuit 110b. The syndrome generator 112, the comparator 114, and the data corrector 115 may be controlled to perform either an error correction operation or an erasure correction operation depending on a mode.

In an embodiment, in a first mode, the syndrome generator 112, the comparator 114, and the data corrector 115 may be used to perform an error correction operation. In a second mode, the syndrome generator 112, the comparator 114, and the data corrector 115 may be used to perform an erasure correction operation. For example, based on a disabled erasure correction enable signal, the syndrome generator 112, the comparator 114, and the data corrector 115 may be configured to perform an error correction operation. Based on an enabled erasure correction enable signal, the syndrome generator 112, the comparator 114, and the data corrector 115 may be configured to perform an erasure correction operation. In this regard, the memory device 100 may operate in the first mode, and when it is determined that the number of erased bits of read data RD exceeds a certain number or that an erased correction result of the read data RD is beyond the correction capability of the memory device 100, the memory device 100 may switch to the second mode and operate. Conversely, the memory device 100 may operate in the second mode, and when it is determined that the number of error bits of read data RD exceeds a certain number or that an error correction result of the read data RD is beyond the correction capability of the memory device 100, the memory device 100 may switch to the first mode and operate. Alternatively, the memory device 100 may operate in the first mode or the second mode under control by the memory controller 11.

Referring to FIG. 5B, the erasure correction circuit 110a may perform an erasure correction operation. The erasure position detector 111 may receive read data RD from the sense amplifier and write driver 160. For example, the erasure position detector 111 may receive read data RD including at least one piece of erased bit data. The read data RD may include user data and parity data. Alternatively, the read data RD may include user data, metadata, and parity data. The read data RD may be a codeword. The erasure position detector 111 may generate erasure position information EP_INFO based on the read data RD. The erasure position information EP_INFO may indicate a position of the erased bit data in the read data RD. For example, the erasure position information EP_INFO may be a bitmap. The erasure position information EP_INFO may include a plurality of status bits corresponding to the read data RD. The erasure position information EP_INFO indicating an erasure position may be stored in a storage location, such as a register, in the form of a word line or bit line of the memory device 100. The erasure position detector 111 may transmit the erasure position information EP_INFO to the syndrome generator 112. The erasure position detector 111 may also transmit the erasure position information EP_INFO to the erasure syndrome set generator 113.

In an embodiment, the syndrome generator 112 may receive the erasure position information EP_INFO and the read data RD. The syndrome generator 112 may receive the erasure position information EP_INFO from the erasure position detector 111. The syndrome generator 112 may receive the read data RD from the sense amplifier and write driver 160. Alternatively, the syndrome generator 112 may receive the erasure position information EP_INFO and the read data RD from the erasure position detector 111.

In an embodiment, the syndrome generator 112 may generate a partial syndrome PS. The syndrome generator 112 may generate the partial syndrome PS based on the erasure position information EP_INFO, the read data RD, and an H-matrix H-MAT. The syndrome generator 112 may transform the read data RD into transformed data TD based on the erasure position information EP_INFO. The syndrome generator 112 may generate the transformed data TD by setting the erased bit data in the read data RD to the second value (e.g., ‘0’). The syndrome generator 112 may generate the partial syndrome PS based on the transformed data TD and the H-matrix H-MAT. The syndrome generator 112 may generate the partial syndrome PS by performing a syndrome calculation on the transformed data TD and the H-matrix H-MAT. The syndrome generator 112 may transmit the partial syndrome PS to the comparator 114.

The erasure syndrome set generator 113 may receive the erasure position information EP_INFO from the erasure position detector 111. The erasure syndrome set generator 113 may generate an erasure syndrome set ESS. The erasure syndrome set ESS may include a plurality of erasure syndromes. The erasure syndrome set generator 113 may generate the erasure syndrome set ESS based on the erasure position information EP_INFO and the H-matrix H-MAT. The erasure syndrome set generator 113 may transmit the erasure syndrome set ESS to the comparator 114.

The comparator 114 may receive the partial syndrome PS and the erasure syndrome set ESS. The comparator 114 may receive the partial syndrome PS from the syndrome generator 112. The comparator 114 may receive the erasure syndrome set ESS from the erasure syndrome set generator 113. The comparator 114 may perform a comparison operation of comparing the partial syndrome PS with each of the erasure syndromes included in the erasure syndrome set ESS. By performing the comparison operation, the comparator 114 may determine an erasure syndrome identical to the partial syndrome PS in the erasure syndrome set ESS.

The comparator 114 may determine a value of erased bit data based on a calculation result. The comparator 114 may determine the value of the erased bit data based on the erasure syndrome identical to the partial syndrome PS. The comparator 114 may transmit a comparison result CR to the data corrector 115. For example, the comparison result CR may include a value of at least one piece of erased bit data. The comparison result CR may further include an erasure syndrome.

The data corrector 115 may receive the comparison result CR from the comparator 114. The data corrector 115 may correct the read data RD based on the comparison result CR. The data corrector 115 may generate corrected data CD by correcting the read data RD. The data corrector 115 may change at least one third value (e.g., ‘X’) included in the read data RD to the value of at least one piece of erased bit data included in the comparison result CR. The data corrector 115 may generate corrected data CD that does not include erased bit data. The data corrector 115 may output the corrected data CD to the input/output circuit 170.

Referring to FIG. 5C, the error correction circuit 110b may perform an error detection and correction operation. The syndrome generator 112 may receive read data RD including only non-erased bit data. The syndrome generator 112 may generate a syndrome SDR based on the read data RD. The syndrome generator 112 may transmit the syndrome SDR to the comparator 114.

The comparator 114 may receive the syndrome SDR and an estimated syndrome. The comparator 114 may compare the syndrome SDR with the estimated syndrome. The comparator 114 may generate a comparison result CR. The comparator 114 may transmit the comparison result CR to the data corrector 115.

The data corrector 115 may receive the comparison result CR from the comparator 114. The data corrector 115 may correct the read data RD based on the comparison result CR. The data corrector 115 may correct the read data RD to generate corrected data CD. The data corrector 115 may output the corrected data CD to the input/output circuit 170.

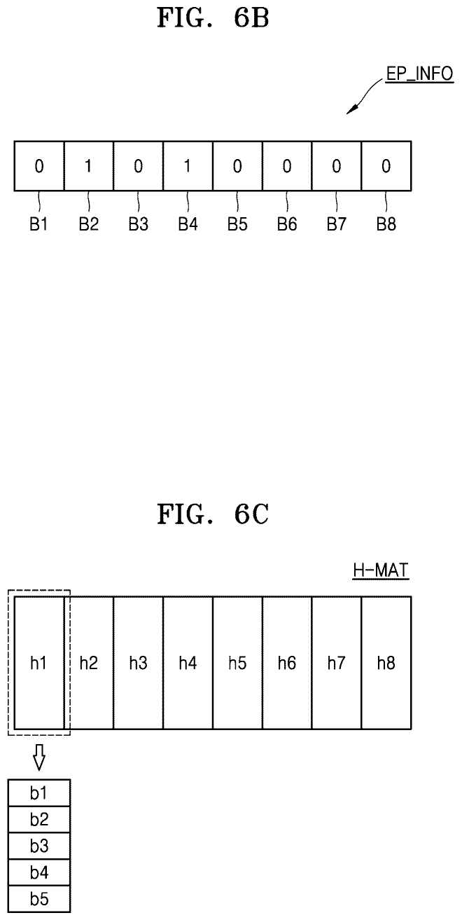

FIGS. 6A to 6C are diagrams illustrating an operation of the correction circuit of FIG. 1 according to an embodiment. An example of read data including erased bit data is described with reference to FIG. 6A. An example of erasure position information is described with reference to FIG. 6B. An example of an H-matrix is described with reference to FIG. 6C.

The correction circuit 110 may receive read data RD. For example, the read data RD may be a code or a codeword. For example, the read data RD may include first to eighth bit data BD1 to BD8. However, the scope of the inventive concept is not limited thereto, and the number of pieces of bit data BD1 to BD8 included in the read data RD may increase or decrease depending on implementation. The first bit data BD1 may have the first value (e.g., ‘1’), the second bit data BD2 may have the third value (e.g., ‘X’), the third bit data BD3 may have the second value (e.g., ‘0’), the fourth bit data BD4 may have the third value (e.g., ‘X’), the fifth bit data BD5 may have the second value (e.g., ‘0’), the sixth bit data BD6 may have the first value (e.g., ‘1’), the seventh bit data BD7 may have the first value (e.g., ‘1’), and the eighth bit data BD8 may have the second value (e.g., ‘0’). The second bit data BD2 and the fourth bit data BD4 may be erased bit data. The read data RD may include at least one piece of erased bit data.

The correction circuit 110 may generate erasure position information EP_INFO. The erasure position information EP_INFO may indicate a position of the erased bit data in the read data RD. For example, the erasure position information EP_INFO may be a bitmap. The erasure position information EP_INFO may include a plurality of status bits corresponding to the read data RD. A status bit may indicate whether corresponding bit data is in an erased state. For example, when the status bit has the first value (e.g., ‘1’), the status bit may indicate that the corresponding bit data is in the erased state. When the status bit has the second value (e.g., ‘0’), the status bit may indicate that the corresponding bit data is in a non-erased state. For example, when the status bit has the first value (e.g., ‘1’), the status bit may indicate that the corresponding bit data is erased bit data. When the status bit has the second value (e.g., ‘0’), the status bit may indicate that the corresponding bit data is non-erased bit data.

For example, the erasure position information EP_INFO may include first to eighth status bits B1 to B8. The first to eighth status bits B1 to B8 may correspond to the first to eighth bit data BD1 to BD8, respectively. For example, the first status bit B1 may indicate erasure status information for the first bit data BD1, and the second status bit B2 may indicate erasure status information for the second bit data BD2, the third status bit B3 may indicate erasure status information for the third bit data BD3, and the fourth status bit B4 may indicate erasure status information for the fourth bit data BD4. The fifth to eighth status bits B5 to B8 are identical or similar thereto, and thus, detailed descriptions thereof are omitted.

For example, because the first bit data BD1 has the first value (e.g., ‘1’), the first status bit B1 may have the second value (e.g., ‘0’). Because the second bit data BD2 has the third value (e.g., ‘X’), the second status bit B2 may have the first value (e.g., ‘1’). Because the third bit data BD3 has the second value (e.g., ‘0’), the third status bit B3 may have the second value (e.g., ‘0’). Because the fourth bit data BD4 has the third value (e.g., ‘X’), the fourth status bit B4 may have the first value (e.g., ‘1’).

Because the fifth bit data BD5 has the second value (e.g., ‘0’), the fifth status bit B5 may have the second value (e.g., ‘0’). Because the sixth bit data BD6 has the first value (e.g., ‘1’), the sixth status bit B6 may have the second value (e.g., ‘0’). Because the seventh bit data BD7 has the first value (e.g., ‘1’), the seventh status bit B7 may have the second value (e.g., ‘0’). Because the eighth bit data BD8 has the second value (e.g., ‘0’), the eighth status bit B8 may have the second value (e.g., ‘0’).

The correction circuit 110 may generate a syndrome based on an H-matrix H-MAT. For example, the H-matrix H-MAT may be a parity check matrix. Column vectors included in the H-matrix H-MAT may be arranged in order of decreasing weight. For example, the column vectors may be arranged according to |hᵢ|≤|hᵢ₊₁|.

For example, the H-matrix H-MAT may include first to eighth column vectors h1 to h8. However, the scope of the inventive concept is not limited thereto, and the number of column vectors may increase or decrease depending on implementation. In an embodiment, each column vector may be a binary vector having a length of 5 bits. For example, the first column vector h1 may be as shown in Expression 1.

$$h 1 = [ \begin{matrix}b 1 \\ b 2 \\ b 3 \\ b 4 \\ b 5\end{matrix} ] \qquad [ Expression 1 ]$$

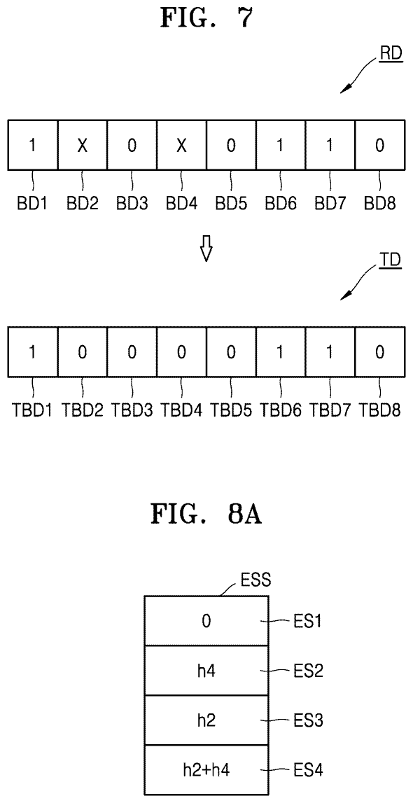

FIG. 7 is a diagram illustrating an operation of the correction circuit of FIG. 1 according to an embodiment. A method of generating a partial syndrome is described with reference to FIG. 7.

Referring to FIGS. 1 and 7, the correction circuit 110 may generate a partial syndrome PS. The correction circuit 110 may generate transformed data TD by setting the erased bit data to ‘0’. For example, the correction circuit 110 may change the third value (e.g., ‘X’) to the second value (e.g., ‘0’) in the read data RD. Therefore, the transformed data TD may not include erased bit data. For example, the transformed data TD may include first to eighth transformed bit data TBD1 to TBD8. The first to eighth transformed bit data TBD1 to TBD8 may correspond to the first to eighth bit data BD1 to BD8, respectively. The first transformed bit data TBD1 may correspond to the first bit data BD1, and the second transformed bit data TBD2 may correspond to the second bit data BD2. The third to eighth transformed bit data TBD3 to TBD8 are identical or similar thereto, and thus, detailed descriptions thereof are omitted.

The correction circuit 110 may generate the transformed data TD based on the read data RD. The correction circuit 110 may maintain a value of non-erased bit data the same and may set a value of erased bit data to the second value (e.g., ‘0’). Because the second bit data BD2 and the fourth bit data BD4 are erased bit data, the correction circuit 110 may set the second transformed bit data TBD2 to the second value (e.g., ‘0’) and may set the fourth transformed bit data TBD4 to the second value (e.g., ‘0’). Accordingly, the first transformed bit data TBD1 may have the first value (e.g., ‘1’), the second transformed bit data TBD2 may have the second value (e.g., ‘0’), the third transformed bit data TBD3 may have the second value (e.g., ‘0’), the fourth transformed bit data TBD4 may have the second value (e.g., ‘0’), the fifth transformed bit data TBD5 may have the second value (e.g., ‘0’), the sixth transformed bit data TBD6 may have the first value (e.g., ‘1’), the seventh transformed bit data TBD7 may have the first value (e.g., ‘1’), and the eighth transformed bit data TBD8 may have the second value (e.g., ‘0’).

The correction circuit 110 may generate a partial syndrome PS. The correction circuit 110 may calculate the partial syndrome PS based on the transformed data TD and the H-matrix H-MAT. For example, the partial syndrome PS may be defined by Expression 2. The correction circuit 110 may calculate the partial syndrome PS based on Expression 2. Here, PS may indicate the partial syndrome PS, TD^{T} may indicate a transpose matrix of the transformed data TD, and H may indicate the H-matrix H-MAT.

$$P S = H \times T {D}^{T} \qquad [ Expression 2 ]$$

For example, because the transformed data TD is ‘10000110’, the partial syndrome PS may be ‘h1+h6+h7’.

As described above, the correction circuit 110 may generate the partial syndrome PS. The correction circuit 110 may generate the transformed data TD by setting at least one piece of erased bit data of the read data RD to ‘0’. The correction circuit 110 may calculate the partial syndrome PS based on the transformed data TD and the H-matrix H-MAT.

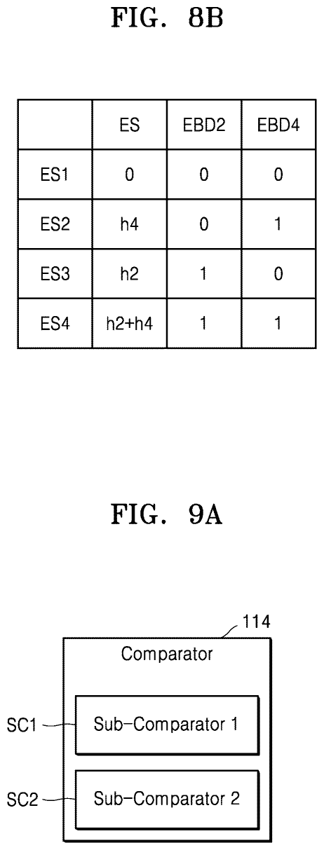

FIGS. 8A and 8B are diagrams illustrating an operation of the correction circuit of FIG. 1 according to an embodiment. A method of generating an erasure syndrome set is described with reference to FIGS. 8A and 8B.

Referring to FIGS. 1, 8A, and 8B, the correction circuit 110 may generate an erasure syndrome set ESS including a plurality of erasure syndromes. In an embodiment, the correction circuit 110 may generate the erasure syndrome set ESS based on the erasure position information EP_INFO and the H-matrix H-MAT. The correction circuit 110 may generate a partial H-matrix. The correction circuit 110 may generate the partial H-matrix based on the erasure position information EP_INFO and the H-matrix H-MAT. For example, the partial H-matrix may include column vectors corresponding to the erased bit data, from among the first to eighth column vectors h1 to h8 included in the H-matrix H-MAT.

For example, in the erasure position information EP_INFO, because the second status bit B2 has the first value (e.g., ‘1’) and the fourth status bit B4 has the first value (e.g., ‘1’), the partial H-matrix may be [h2 h4]. That is, the partial H-matrix may include the second and fourth column vectors h2 and h4 corresponding to pieces of erased bit data.

In an embodiment, the correction circuit 110 may generate a binary combination matrix. The correction circuit 110 may generate the binary combination matrix according to the number of pieces of erased bit data included in the read data RD, that is, the number of erasures. For example, the term “number of erasures” may refer to the number of pieces of erased bit data included in the read data RD. The binary combination matrix may be determined by the number of erasures. The binary combination matrix may include the number of cases or combinations of bits corresponding to the number of pieces of erased bit data.

For example, the correction circuit 110 may determine the number of erasures based on the erasure position information EP_INFO. The correction circuit 110 may determine the number of erasures by counting the number of first values (e.g., ‘1’) in the erasure position information EP_INFO. In the erasure position information EP_INFO, because the second status bit B2 has the first value (e.g., ‘1’) and the fourth status bit B4 has the first value (e.g., ‘1’), the number of erasures may be ‘2’.

The correction circuit 110 may determine the binary combination matrix based on the number of erasures. For example, when the number of erasures is ‘2’, the binary combination matrix may be defined by Expression 3. When the number of erasures is ‘3’, the binary combination matrix may be defined by Expression 4.

$$BC - MAT = [ \begin{matrix}0 & 0 & 1 & 1 \\ 0 & 1 & 0 & 1\end{matrix} ] \qquad [ Expression 3 ]$$

$$BC - MAT = [ \begin{matrix}0 & 1 & 0 & 0 & 1 & 1 & 0 & 1 \\ 0 & 0 & 1 & 0 & 1 & 0 & 1 & 1 \\ 0 & 0 & 0 & 1 & 0 & 1 & 1 & 1\end{matrix} ] \qquad [ Expression 4 ]$$

In an embodiment, the correction circuit 110 may generate the erasure syndrome set ESS based on the partial H-matrix and the binary combination matrix. The erasure syndrome set ESS may include a plurality of erasure syndromes. For example, the erasure syndrome set ESS may be a matrix, and each element thereof may be an erasure syndrome.

In an embodiment, the correction circuit 110 may calculate the erasure syndrome set ESS based on Expression 5. The erasure syndrome set ESS may be defined by Expression 5. The correction circuit 110 may generate the erasure syndrome set ESS by performing a multiplication calculation on the partial H-matrix and the binary combination matrix. For example, the erasure syndrome set ESS may have a various data structures, such as a matrix, a set, a table, and a list.

$$ESS = PH - MAT \times BC - MAT \qquad [ Expression 5 ]$$

For example, the erasure syndrome set ESS may include first to fourth erasure syndromes ES1 to ES4. The first erasure syndrome ES1 may be ‘0’. The second erasure syndrome ES2 may be ‘h4’. The third erasure syndrome ES3 may be ‘h2’. The fourth erasure syndrome ES4 may be ‘h2+h4’.

$$ES = h 2 \cdot EBD 2 + h 4 \cdot EBD 4 \qquad [ Expression 6 ]$$

Each of the first to fourth erasure syndromes ES1 to ES4 may be related to Expression 6. For example, when second estimated bit data EBD2 has the second value (e.g., ‘0’) and fourth estimated bit data EBD4 has the second value (e.g., ‘0’), the first erasure syndrome ES1 may be ‘0’. When the second estimated bit data EBD2 has the second value (e.g., ‘0’) and the fourth estimated bit data EBD4 has the first value (e.g., ‘1’), the second erasure syndrome ES2 may be ‘h4’. When the second estimated bit data EBD2 has the first value (e.g., ‘1’) and the fourth estimated bit data EBD4 has the second value (e.g., ‘0’), the third erasure syndrome ES3 may be ‘h2’. When the second estimated bit data EBD2 has the first value (e.g., ‘1’) and the fourth estimated bit data EBD4 has the first value (e.g., ‘1’), the fourth erasure syndrome ES4 may be ‘h2+h4’.

As described above, the correction circuit 110 may generate the erasure syndrome set ESS. The correction circuit 110 may generate a partial H-matrix including a column vector corresponding to at least one piece of erased bit data, from among the first to eighth column vectors h1 to h8 of the H-matrix H-MAT. The correction circuit 110 may generate a binary combination matrix based on the number of at least one piece of erased bit data included in the read data RD. The correction circuit 110 may generate the erasure syndrome set ESS based on the partial H-matrix and the binary combination matrix.

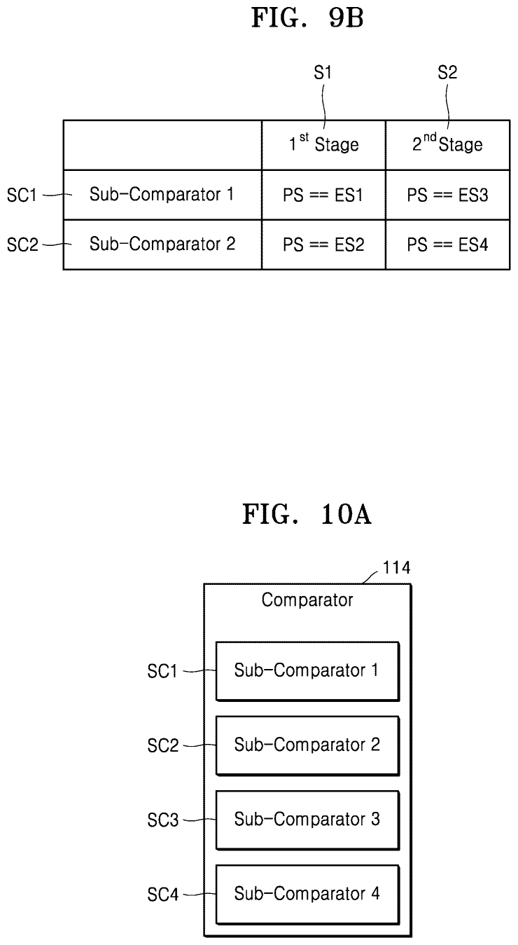

FIGS. 9A and 9B are diagrams illustrating an operation of the correction circuit of FIGS. 1 and 5A according to an embodiment. FIGS. 10A and 10B are diagrams illustrating an operation of the correction circuit of FIGS. 1 and 5A according to an embodiment. A method of selecting an erasure syndrome identical to a partial syndrome in an erasure syndrome set is described with reference to FIGS. 9A, 9B, 10A, and 10B.

The comparator 114 may receive the partial syndrome PS and the erasure syndrome set ESS. The comparator 114 may receive the partial syndrome PS from the syndrome generator 112. The comparator 114 may receive the erasure syndrome set ESS from the erasure syndrome set generator 113.

The comparator 114 may perform a comparison operation. The term “comparison operation” may refer to an operation of comparing the partial syndrome PS with each of the first to fourth erasure syndromes ES1 to ES4. For example, the comparator 114 may compare the partial syndrome PS with the first erasure syndrome ES1. The comparator 114 may determine whether the partial syndrome PS and the first erasure syndrome ES1 are identical to each other.

In an embodiment, the comparator 114 may select an erasure syndrome identical to the partial syndrome PS in the erasure syndrome set ESS. The comparator 114 may find an erasure syndrome identical to the partial syndrome PS, from among the first to fourth erasure syndromes ES1 to ES4. By performing the comparison operation, the comparator 114 may determine an erasure syndrome identical to the partial syndrome PS.

Referring to FIGS. 9A and 9B, the comparator 114 may include a first sub-comparator SC1 and a second sub-comparator SC2. Each of the first sub-comparator SC1 and the second sub-comparator SC2 may perform a comparison calculation on the partial syndrome PS and a received erasure syndrome. Each of the first sub-comparator SC1 and the second sub-comparator SC2 may output a calculation result. For example, when the calculation result indicates the first value (e.g., ‘1’), the calculation result may indicate a state in which the partial syndrome PS and a received erasure syndrome are not identical to each other. When the calculation result indicates the second value (e.g., ‘0’), the calculation result may indicate a state in which the partial syndrome PS and a received erasure syndrome are identical to each other. For example, because the number of erasure syndromes is ‘4’ and the number of sub-comparators is ‘2’, comparison calculations may be performed twice in units of two.

In an embodiment, the comparator 114 may perform comparison calculations in a first stage S1. For example, in the first stage S1, the first sub-comparator SC1 may receive the partial syndrome PS and the first erasure syndrome ES1. The first sub-comparator SC1 may perform a comparison calculation on the partial syndrome PS and the first erasure syndrome ES1 and may output a first calculation result. The first sub-comparator SC1 may determine whether the partial syndrome PS and the first erasure syndrome ES1 are identical to each other.

In the first stage S1, the second sub-comparator SC2 may receive the partial syndrome PS and the second erasure syndrome ES2. The second sub-comparator SC2 may perform a comparison calculation on the partial syndrome PS and the second erasure syndrome ES2 and may output a second calculation result. The second sub-comparator SC2 may determine whether the partial syndrome PS and the second erasure syndrome ES2 are identical to each other.

In the first stage S1, at the same time that the first sub-comparator SC1 performs a comparison calculation, the second sub-comparator SC2 may perform a comparison calculation. In the first stage S1, the comparison calculations may be performed in parallel in the first and second sub-comparators SC1 and SC2, respectively. After the comparison calculations are completed in the first stage S1, the comparator 114 may perform comparison calculations in a second stage S2.

In the second stage S2, the first sub-comparator SC1 may receive the partial syndrome PS and the third erasure syndrome ES3. The first sub-comparator SC1 may perform a comparison calculation on the partial syndrome PS and the third erasure syndrome ES3 and may output a third calculation result. The first sub-comparator SC1 may determine whether the partial syndrome PS and the third erasure syndrome ES3 are identical to each other.

In the second stage S2, the second sub-comparator SC2 may receive the partial syndrome PS and the fourth erasure syndrome ES4. The second sub-comparator SC2 may perform a comparison calculation on the partial syndrome PS and the fourth erasure syndrome ES4 and may output a fourth calculation result. The second sub-comparator SC2 may determine whether the partial syndrome PS and the fourth erasure syndrome ES4 are identical to each other.

In the second stage S2, at the same time that the first sub-comparator SC1 performs a comparison calculation, the second sub-comparator SC2 may perform a comparison calculation. In the second stage S2, the comparison calculations may be performed in parallel in the first and second sub-comparators SC1 and SC2, respectively.

In an embodiment, when either the first calculation result or the second calculation result indicates the second value (e.g., ‘0’) (i.e., a state in which the partial syndrome PS and a received erasure syndrome are identical to each other) in the first stage S1, the comparator 114 may not perform a comparison calculation in the second stage S2. Because the comparator 114 has found an erasure syndrome identical to the partial syndrome PS in the erasure syndrome set ESS, the comparator 114 may not perform a comparison calculation in the second stage S2.

In an embodiment, when the first calculation result indicates the first value (e.g., ‘1’) (i.e., a state in which the partial syndrome PS and a received erasure syndrome are not identical to each other), and the second calculation result indicates the first value (e.g., ‘1’) (i.e., a state in which the partial syndrome PS and a received erasure syndrome are not identical to each other) in the first stage S1, the comparator 114 may perform a comparison calculation in the second stage S2.

Referring to FIGS. 10A and 10B, the comparator 114 may include first to fourth sub-comparators SC1 to SC4. Each of the first to fourth sub-comparators SC1 to SC4 may perform a comparison calculation on the partial syndrome PS and a received erasure syndrome. Each of the first to fourth sub-comparators SC1 to SC4 may output a calculation result. For example, because the number of erasure syndromes is ‘4’ and the number of sub-comparators is ‘4’, comparison calculations may be performed once in units of four.

For example, in the first stage S1, the first sub-comparator SC1 may receive the partial syndrome PS and the first erasure syndrome ES1. The first sub-comparator SC1 may perform a comparison calculation on the partial syndrome PS and the first erasure syndrome ES1 and may output a first calculation result. The first sub-comparator SC1 may determine whether the partial syndrome PS and the first erasure syndrome ES1 are identical to each other.

In the first stage S1, the second sub-comparator SC2 may receive the partial syndrome PS and the second erasure syndrome ES2. The second sub-comparator SC2 may perform a comparison calculation on the partial syndrome PS and the second erasure syndrome ES2 and may output a second calculation result. The second sub-comparator SC2 may determine whether the partial syndrome PS and the second erasure syndrome ES2 are identical to each other.

In the first stage S1, the first sub-comparator SC1 may receive the partial syndrome PS and the third erasure syndrome ES3. The first sub-comparator SC1 may perform a comparison calculation on the partial syndrome PS and the third erasure syndrome ES3 and may output a third calculation result. The first sub-comparator SC1 may determine whether the partial syndrome PS and the third erasure syndrome ES3 are identical to each other.

In the first stage S1, the second sub-comparator SC2 may receive the partial syndrome PS and the fourth erasure syndrome ES4. The second sub-comparator SC2 may perform a comparison calculation on the partial syndrome PS and the fourth erasure syndrome ES4 and may output a fourth calculation result. The second sub-comparator SC2 may determine whether the partial syndrome PS and the fourth erasure syndrome ES4 are identical to each other. In the first stage S1, the comparison calculations may be performed in parallel in the first to fourth sub-comparators SC1 to SC4, respectively.

In an embodiment, the comparator 114 may generate a comparison result CR. The comparison result CR may include a value of at least one piece of erased bit data. The comparison result CR may further include an erasure syndrome or erasure position information EP_INFO. The comparator 114 may transmit the comparison result CR to the data corrector 115.

For example, the second erasure syndrome ES2 may be identical to the partial syndrome PS. The comparator 114 may find the second erasure syndrome ES2 that is identical to the partial syndrome PS in the erasure syndrome set ESS. Because the second erasure syndrome ES2 is identical to the partial syndrome PS, the comparator 114 may determine the second bit data BD2 as the second value (e.g., ‘0’) and may determine the fourth bit data BD4 as the first value (e.g., ‘1’). The comparator 114 may determine a value of erased bit data based on the second erasure syndrome ES2. The comparator 114 may generate a comparison result CR including the second value of the second bit data BD2 and the first value of the fourth bit data BD4. The comparator 114 may transmit the comparison result CR to the data corrector 115.

As described above, the comparator 114 may determine whether an erasure syndrome identical to the partial syndrome PS is present in the erasure syndrome set ESS. The comparator 114 may compare whether the partial syndrome PS and the first erasure syndrome ES1 are identical to each other, may compare whether the partial syndrome PS and the second erasure syndrome ES2 are identical to each other, may compare whether the partial syndrome PS and the third erasure syndrome ES3 are identical to each other, and may compare whether the partial syndrome PS and the fourth erasure syndrome ES4 are identical to each other. The comparator 114 may generate a comparison result CR based on an erasure syndrome identical to the partial syndrome PS among the first to fourth erasure syndromes ES1 to ES4. The comparison result CR may include a value of at least one piece of estimated bit data corresponding to the erasure syndrome identical to the partial syndrome PS.

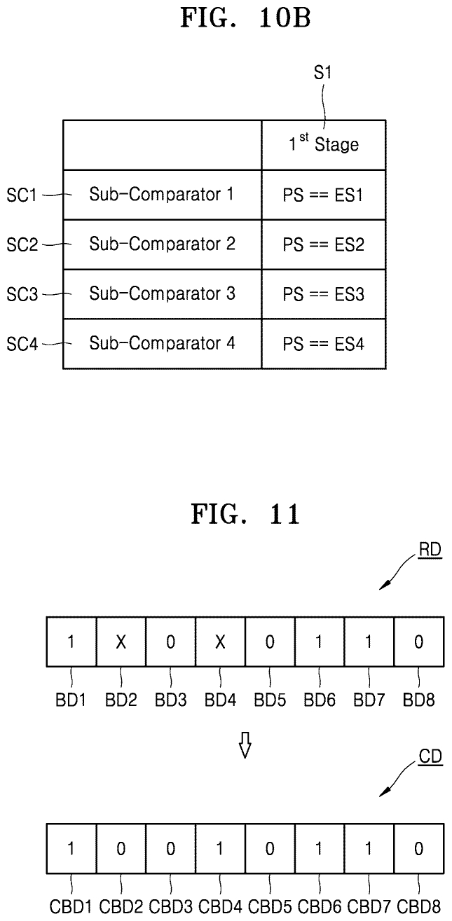

FIG. 11 is a diagram illustrating an operation of the correction circuit of FIGS. 1 and 5A according to an embodiment. A method of generating corrected data is described with reference to FIG. 11.

Referring to FIGS. 1, 5A, and 11, the data corrector 115 may perform a data correction operation. The data corrector 115 may generate corrected data CD. For example, the corrected data CD may include first to eighth corrected bit data CBD1 to CBD8. The first to eighth corrected bit data CBD1 to CBD8 may correspond to the first to eighth bit data BD1 to BD8, respectively. The first corrected bit data CBD1 may correspond to the first bit data BD1, and the second corrected bit data CBD2 may correspond to the second bit data BD2. The third to eighth corrected bit data CBD3 to CBD8 are identical or similar thereto, and thus, detailed descriptions thereof are omitted.

The data corrector 115 may receive the read data RD and the comparison result CR. The data corrector 115 may correct the read data RD based on the comparison result CR. The data corrector 115 may generate the corrected data CD based on the comparison result CR and the read data RD.

The data corrector 115 may maintain a value of non-erased bit data the same. The data corrector 115 may correct the erased bit data of the read data RD. Because the second bit data BD2 and the fourth bit data BD4 are erased bit data, the value of the second estimated bit data EBD2 included in the comparison result CR is the second value (e.g., ‘0’), and the value of the fourth estimated bit data EBD4 included in the comparison result CR is the first value (e.g., ‘1’), the data corrector 115 may set the second corrected bit data CBD2 to the second value (e.g., ‘0’) and may set the fourth corrected bit data CBD4 to the first value (e.g., ‘1’).

Accordingly, the first corrected bit data CBD1 may have the first value (e.g., ‘1’), the second corrected bit data CBD2 may have the second value (e.g., ‘0’), the third corrected bit data CBD3 may have the second value (e.g., ‘0’), the fourth corrected bit data CBD4 may have the first value (e.g., ‘1’), the fifth corrected bit data CBD5 may have the second value (e.g., ‘0’), the sixth corrected bit data CBD6 may have the first value (e.g., ‘1’), the seventh corrected bit data CBD7 may have the first value (e.g., ‘1’), and the eighth corrected bit data CBD8 may have the second value (e.g., ‘0’).

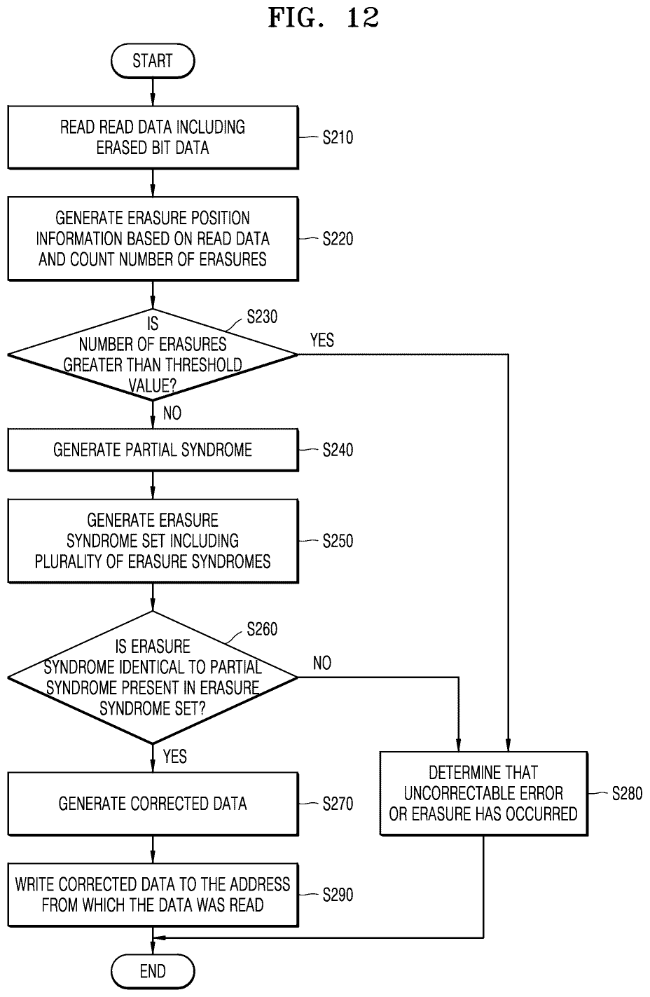

FIG. 12 is a flowchart illustrating an example of an operating method of the memory device of FIGS. 1 and 5A according to an embodiment.

Referring to FIGS. 1, 5A, and 12, the memory device 100 may perform an erasure correction operation. In an embodiment, the memory device 100 may receive a read command from the memory controller 11. The memory device 100 may read read data RD from the memory cell array 120, in response to the read command. For example, the read command may include an address. The memory device 100 may read, from the memory cell array 120, read data RD corresponding to the address.

Operations S210, S240, S250, S260, S270, and S280 of FIG. 12 may correspond to operations S110, S130, S140, S150, S160, and S170 of FIG. 4, respectively. For convenience of description, detailed descriptions thereof are omitted.

In operation S210, the memory device 100 may read, from the memory cell array 120, read data RD including erased bit data. In operation S220, the memory device 100 may generate erasure position information EP_INFO based on the read data RD and may count the number of erasures. The erasure position information EP_INFO may include position information of the erased bit data included in the read data RD. The memory device 100 may count, based on the erasure position information EP_INFO or the read data RD, the number of pieces of erased bit data included in the read data RD. The number of erasures may indicate the number of pieces of erased bit data. The memory device 100 may count the number of erasures in the read data RD.

In operation S230, the memory device 100 may determine whether the number of erasures is greater than a threshold value. The threshold value may be predetermined. When the number of erasures is greater than the threshold value, the correction capability of the correction circuit 110 may be exceeded, and thus, the erasure correction operation may not be performed. When the number of erasures is greater than the threshold value, the memory device 100 may perform operation S280, and when the number of erasures is less than or equal to the threshold value, the memory device 100 may perform operation S240.

In operation S240, the memory device 100 may generate a partial syndrome PS. In operation S250, the memory device 100 may generate an erasure syndrome set ESS. In operation S260, the memory device 100 may determine whether an erasure syndrome identical to the partial syndrome PS is present in the erasure syndrome set ESS. When an erasure syndrome identical to the partial syndrome PS is present in the erasure syndrome set ESS, the memory device 100 may perform operation S270, and when an erasure syndrome identical to the partial syndrome PS is not present in the erasure syndrome set ESS, the memory device 100 may perform operation S280. In operation S270, the memory device 100 may generate corrected data CD. In operation S280, the memory device 100 may determine that an uncorrectable error or erasure has occurred.

In operation S290, the memory device 100 may perform a write operation on a memory address from which the corrected data CD, in which an erased bit has been corrected, has been read. Such an erasure correction operation may be performed when the memory device 100 receives a read command or when the memory device 100 is in an idle state in which no command is received. By performing the erasure correction operation, the reliability of the memory device 100 may be further increased compared to when the memory device 100 only performs an error correction operation.

In an embodiment, the memory device 100 may transmit the corrected data CD to the memory controller 11. In an embodiment, when erasure correction by the correction circuit 110 of the memory device 100 fails (i.e., when it is determined that an uncorrectable error has occurred), the memory device 100 may notify the memory controller 11 of a decoding failure by using information such as a decoding status flag (DSF).

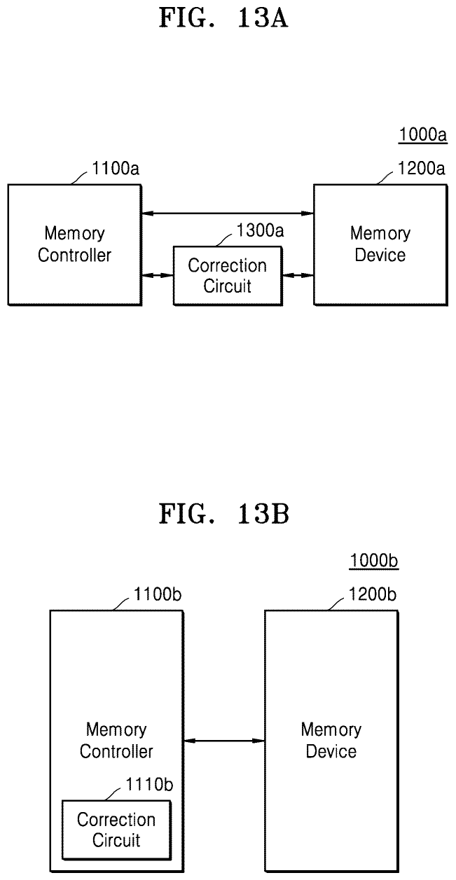

FIGS. 13A and 13B are block diagrams illustrating a memory system according to an embodiment.

Referring to FIG. 13A, a memory system 1000a may include a memory controller 1100a, a memory device 1200a, and a correction circuit 1300a. In an embodiment, the correction circuit 1300a may correspond to the correction circuit 110 of FIG. 1. In an embodiment, the correction circuit 1300a may be located in a data path between the memory controller 1100a and the memory device 1200a. The correction circuit 1300a may be arranged outside the memory controller 1100a. The correction circuit 1300a may be arranged outside the memory device 1200a. The correction circuit 1300a may be configured to correct an error or erasure of data transmitted and received between the memory controller 1100a and the memory device 1200a. The correction circuit 1300a may perform a general error detection and correction operation. At the same time, the correction circuit 1300a may perform an erasure correction operation. In an embodiment, the correction circuit 1300a may receive, from the memory device 1200a, read data including erased bit data. In an embodiment, the correction circuit 1300a may operate based on the operating method described with reference to FIGS. 1, 2, 3A to 3C, 4, 5, 6A to 6C, 7, 8A, 8B, 9A, 9B, 10A, 10B, 11, and 12.

Referring to FIG. 13B, a memory system 1000b may include a memory controller 1100b and a memory device 1200b. The memory controller 1100b may include a correction circuit 1110b. In an embodiment, the correction circuit 1110b may correspond to the correction circuit 110 of FIG. 1. The correction circuit 1110b may be configured to generate parity data for data to be stored in the memory device 1200b or to correct an error in read data based on data and parity data read from the memory device 1200b. The correction circuit 1110b may perform a general error detection and correction operation. At the same time, the correction circuit 1110b may perform an erasure correction operation. The correction circuit 1110b may operate based on the method described with reference to FIGS. 1, 2, 3A to 3C, 4, 5, 6A to 6C, 7, 8A, 8B, 9A, 9B, 10A, 10B, 11, and 12. In an embodiment, the correction circuit 1110b may receive, from the memory device 1200b, read data including erased bit data.

In the embodiments described with reference to FIGS. 1, 2, 3A to 3C, 4, 5, 6A to 6C, 7, 8A, 8B, 9A, 9B, 10A, 10B, 11, and 12, the correction circuit 110 is described as an on-die ECC (OD-ECC) circuit included in the memory device 100, but the scope of the inventive concept is not limited thereto. For example, as described with reference to FIGS. 13A and 13B, the correction circuit may be located outside the memory device, or in the memory controller.

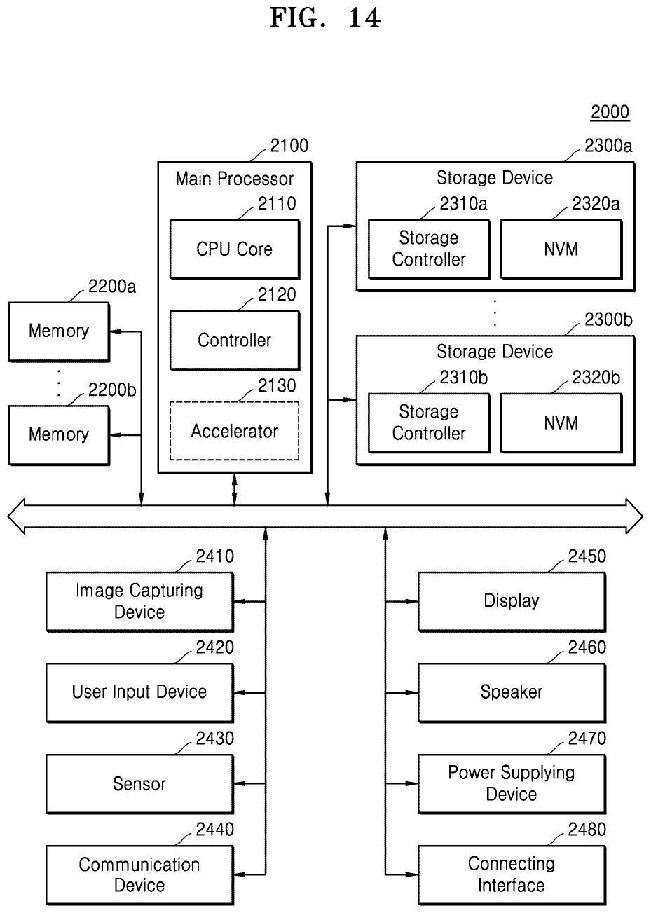

FIG. 14 is a diagram illustrating a system 2000 according to an embodiment.

The system 2000 of FIG. 14 may basically be a mobile system, such as a mobile phone, a smartphone, a tablet PC, a wearable device, a healthcare device, or an Internet of Things (IOT) device. However, the system 2000 of FIG. 14 is not necessarily limited to the mobile system, and may be a PC, a laptop computer, a server, a media player, or an automotive device, such as a navigation device.

Referring to FIG. 14, the system 2000 may include a main processor 2100, memories 2200a and 2200b, and storage devices 2300a and 2300b and may further include at least one of an image capturing device 2410, a user input device 2420, a sensor 2430, a communication device 2440, a display 2450, a speaker 2460, a power supplying device 2470, and a connecting interface 2480.

The main processor 2100 may control an overall operation of the system 2000, and more particularly, operations of other components constituting the system 2000. The main processor 2100 may be implemented as a general-purpose processor, a dedicated processor, or an application processor.

The main processor 2100 may include at least one central processing unit (CPU) core 2110 and may further include a controller 2120 for controlling the memories 2200a and 2200b and/or the storage devices 2300a and 2300b. Depending on embodiments, the main processor 2100 may further include an accelerator 2130 that is a dedicated circuit for high-speed data calculation, such as artificial intelligence (AI) data calculation. The accelerator 2130 may include a graphics processing unit (GPU), a neural processing unit (NPU), and/or a data processing unit (DPU) and may be implemented as a separate chip physically independent of other components of the main processor 2100.

The memories 2200a and 2200b may be used as main memory devices of the system 2000 and may include volatile memories, such as SRAM and/or DRAM, but may also include non-volatile memories, such as flash memory, FRAM, PRAM, and/or RRAM. The memories 2200a and 2200b may also be implemented in the same package as the main processor 2100.

The storage devices 2300a and 2300b may function as non-volatile storage devices that store data regardless of whether power is supplied thereto, and may have a relatively larger storage capacity than the memories 2200a and 2200b. The storage devices 2300a and 2300b may include storage controllers 2310a and 2310b and non-volatile memories (NVMs) 2320a and 2320b that store data under control by the storage controllers 2310a and 2310b. The non-volatile storage 2320a and 2320b may include flash memory having a two-dimensional (2D) structure or a three-dimensional (3D) vertical NAND (V-NAND) structure, but may also include other types of non-volatile memory, such as PRAM and/or RRAM.

The storage devices 2300a and 2300b may be included in the system 2000 in a state of being physically separated from the main processor 2100 or may be implemented in the same package as the main processor 2100. Also, the storage devices 2300a and 2300b may have a form, such as a solid-state device (SSD) or a memory card, and thus may be detachably coupled to other components of the system 2000 via an interface, such as the connecting interface 2480 to be described below. The storage devices 2300a and 2300b may be devices to which a standard protocol, such as Universal Flash Storage (UFS), embedded Multi-Media Card (eMMC), or Non-Volatile Memory express (NVMe), is applied, but are not necessarily limited thereto.

The image capturing device 2410 may capture a still image or a moving image and may be a camera, a camcorder, and/or a webcam.

The user input device 2420 may receive various types of data input from a user of the system 2000 and may be a touch pad, a keypad, a keyboard, a mouse, and/or a microphone.

The sensor 2430 may sense various types of physical quantities that may be obtained from the outside of the system 2000 and may convert the sensed physical quantities into electrical signals. The sensor 2430 may be a temperature sensor, a pressure sensor, an illuminance sensor, a position sensor, an acceleration sensor, a biosensor, and/or a gyroscope sensor.

The communication device 2440 may transmit and receive signals to and from other devices outside the system 2000 according to various communication protocols. The communication device 2440 may be implemented by including an antenna, a transceiver, and/or a modem.

The display 2450 and the speaker 2460 may function as output devices that respectively output visual information and auditory information to the user of the system 2000.

The power supplying device 2470 may appropriately convert power supplied from a battery (not shown) built into the system 2000 and/or an external power source and may supply the converted power to each component of the system 2000.

The connecting interface 2480 may provide a connection between the system 2000 and an external device connected to the system 2000 and capable of exchanging data with the system 2000. The connecting interface 2480 may be implemented in various interface methods, such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVM express (NVMe), IEEE 1394, Universal Serial Bus (USB), secure digital (SD) card, multi-media card (MMC), embedded MMC (eMMC), Universal Flash Storage (UFS), embedded UFS (eUFS), and compact flash (CF) card interface.

In an embodiment, the memories 2200a and 2200b may be memory devices including the correction circuit described with reference to FIGS. 1, 2, 3A to 3C, 4, 5, 6A to 6C, 7, 8A, 8B, 9A, 9B, 10A, 10B, 11, and 12 and may operate based on the method described with reference to FIGS. 1, 2, 3A to 3C, 4, 5, 6A to 6C, 7, 8A, 8B, 9A, 9B, 10A, 10B, 11, and 12.

While the inventive concept has been particularly shown and described with reference to embodiments thereof, it will be understood that various changes in form and details may be made therein without departing from the spirit and scope of the present invention as set forth in the following claims.

What is claimed is:

1. An operating method of a memory device, the operating method comprising:
reading, from a memory cell array in the memory device, read data including at least one piece of erased bit data;
generating erasure position information based on the read data;
generating a partial syndrome associated with non-erased bit data of the read data, based on the erasure position information, an H-matrix, and the read data;
generating, based on the erasure position information and the H-matrix, an erasure syndrome set associated with the at least one piece of erased bit data and including a plurality of erasure syndromes;
determining whether an erasure syndrome identical to the partial syndrome is present in the erasure syndrome set; and
generating corrected data by correcting the read data based on the erasure syndrome identical to the partial syndrome.

2. The operating method of claim 1, wherein, in the read data, the non-erased bit data excluding erased bit data has either a first value or a second value, and the erased bit data has a third value, and
wherein the first value, the second value, and the third value are different from one another.

3. The operating method of claim 1, wherein the erasure position information includes information about a position of the at least one piece of erased bit data of the read data.

4. The operating method of claim 1, wherein the generating of the partial syndrome includes:
generating transformed data by setting the at least one piece of erased bit data of the read data to ‘0’; and
calculating the partial syndrome based on the transformed data and the H-matrix.

5. The operating method of claim 1, wherein the generating of the erasure syndrome set includes:
generating a partial H-matrix including a column vector corresponding to the at least one piece of erased bit data, from among column vectors of the H-matrix;
generating a binary combination matrix based on a number of the at least one piece of erased bit data included in the read data; and
generating the erasure syndrome set based on the partial H-matrix and the binary combination matrix.

6. The operating method of claim 1, wherein the determining of whether an erasure syndrome identical to the partial syndrome is present in the erasure syndrome set includes:
comparing whether the partial syndrome and a first erasure syndrome included in the erasure syndrome set are identical to each other; and
comparing whether the partial syndrome and a second erasure syndrome included in the erasure syndrome set are identical to each other.

7. The operating method of claim 6, wherein the determining of whether an erasure syndrome identical to the partial syndrome is present in the erasure syndrome set further includes generating a comparison result based on the erasure syndrome identical to the partial syndrome, and
wherein the comparison result includes a value of at least one piece of estimated bit data corresponding to the erasure syndrome identical to the partial syndrome.

8. The operating method of claim 7, wherein the generating of the corrected data by correcting the read data based on the erasure syndrome identical to the partial syndrome includes generating the corrected data by correcting the at least one piece of erased bit data of the read data to the value of the at least one piece of estimated bit data included in the comparison result.

9. The operating method of claim 1, further comprising:
when an erasure syndrome identical to the partial syndrome is not present in the erasure syndrome set, determining that an uncorrectable error or erasure has occurred.

10. The operating method of claim 1, wherein the read data includes first read data, and the operating method further comprises:
reading, from the memory cell array, second read data that does not include erased bit data; and
performing an error detection and correction operation on the second read data.

11. A memory device comprising:
a memory cell array including a plurality of memory cells; and
a correction circuit including an error correction circuit and an erasure correction circuit, the error correction circuit being configured to perform an error detection and correction operation on read data read from the memory cell array, and the erasure correction circuit being configured to perform an erasure correction operation on the read data,
wherein the erasure correction circuit includes:
an erasure position detector configured to generate erasure position information based on the read data including at least one piece of erased bit data;
a syndrome generator configured to generate a partial syndrome associated with non-erased bit data of the read data, based on the erasure position information, an H-matrix, and the read data;
an erasure syndrome set generator configured to generate, based on the erasure position information and the H-matrix, an erasure syndrome set associated with erased bit data of the read data and including a plurality of erasure syndromes;
a comparator configured to determine whether an erasure syndrome identical to the partial syndrome is present in the erasure syndrome set; and
a data corrector configured to generate corrected data by correcting the read data based on the erasure syndrome identical to the partial syndrome.

12. The memory device of claim 11, wherein, in the read data, the non-erased bit data excluding the erased bit data has either a first value or a second value, and the erased bit data has a third value, and
wherein the first value, the second value, and the third value are different from one another.

13. The memory device of claim 11, wherein the erasure position detector is further configured to generate erasure position information including information about a position of the at least one piece of erased bit data of the read data.

14. The memory device of claim 11, wherein the syndrome generator is further configured to:
generate transformed data by setting the at least one piece of erased bit data of the read data to ‘0’, and
calculate the partial syndrome based on the transformed data and the H-matrix.

15. The memory device of claim 11, wherein the erasure syndrome set generator is further configured to:
generate a partial H-matrix including a column vector corresponding to the at least one piece of erased bit data, from among column vectors of the H-matrix,
generate a binary combination matrix based on a number of the at least one piece of erased bit data included in the read data, and
generate the erasure syndrome set based on the partial H-matrix and the binary combination matrix.

16. The memory device of claim 11, wherein the comparator is further configured to:
compare whether the partial syndrome and a first erasure syndrome included in the erasure syndrome set are identical to each other,
compare whether the partial syndrome and a second erasure syndrome included in the erasure syndrome set are identical to each other, and
generate a comparison result based on the erasure syndrome identical to the partial syndrome, and
wherein the comparison result includes a value of at least one piece of estimated bit data corresponding to the erasure syndrome identical to the partial syndrome.

17. The memory device of claim 16, wherein the data corrector is further configured to generate the corrected data by correcting the at least one piece of erased bit data of the read data to the value of the at least one piece of estimated bit data included in the comparison result.

18. A memory system comprising:
a memory device including a memory cell array and a correction circuit; and
a memory controller configured to store data in the memory device or read data stored in the memory device,
wherein the correction circuit includes:
an erasure position detector configured to generate erasure position information based on the read data including at least one piece of erased bit data;
a syndrome generator configured to generate a partial syndrome associated with non-erased bit data of the read data, based on the erasure position information, an H-matrix, and the read data;
an erasure syndrome set generator configured to generate, based on the erasure position information and the H-matrix, an erasure syndrome set associated with erased bit data of the read data and including a plurality of erasure syndromes;
a comparator configured to determine whether an erasure syndrome identical to the partial syndrome is present in the erasure syndrome set; and
a data corrector configured to generate corrected data by correcting the read data based on the erasure syndrome identical to the partial syndrome.

19. The memory system of claim 18, wherein the syndrome generator is further configured to:
generate transformed data by setting the at least one piece of erased bit data of the read data to ‘0’, and
calculate the partial syndrome based on the transformed data and the H-matrix.

20. The memory system of claim 18, wherein the erasure syndrome set generator is further configured to:
generate a partial H-matrix including a column vector corresponding to the at least one piece of erased bit data, from among column vectors of the H-matrix,
generate a binary combination matrix based on a number of the at least one piece of erased bit data included in the read data, and
generate the erasure syndrome set based on the partial H-matrix and the binary combination matrix.
